(19) United States
(12) Patent Application Publication
(10) Pub. No.: US 2017/0157923 A1
(43) Pub. Date: Jun. 8, 2017

(54) LIQUID JET HEAD, LIQUID JET RECORDING DEVICE, AND METHOD OF MANUFACTURING LIQUID JET HEAD

(71) Applicant: SII Printek Inc., Chiba-shi (JP)

(72) Inventor: Takanori KOYANO, Chiba-shi (JP)

(21) Appl. No.: 15/353,142

(22) Filed: Nov. 16, 2016

(30) Foreign Application Priority Data
Dec. 8, 2015 (JP) 2015-239558

(51) Int. Cl. B41J 2/14

(52) U.S. Cl. CPC B41J 2/1433

(57) ABSTRACT

A nozzle plate including nozzle arrays with a plurality of nozzle holes, actuator plates to be filled with ink, and a nozzle guard provided so as to cover the nozzle plate for protecting the nozzle plate are included. The nozzle guard includes a frame body formed to surround a periphery of the nozzle plate, and a cover body that blocks an opening portion of the frame body and in which slits that expose the nozzle arrays is formed. The frame body and the cover body are configured separately from each other, and the frame body and the cover body respectively include joint portions to be joined to each other.

### BACKGROUND

Technical Field

The present invention relates to a liquid jet head, a liquid jet recording device, and a method of manufacturing a liquid jet head.

Related Art

A liquid jet recording device (ink jet printer) for various types of printing includes a conveying device that conveys a recording medium and a liquid jet head (ink jet head). The liquid jet head discharges ink supplied form a liquid accommodating body (ink tank) via a liquid supply pipe (ink supply pipe) through a nozzle hole of a head chip provided in the liquid jet head to the recording medium. Accordingly, letters and images are recorded on the recording medium. (As an example, see JP2005-67130A.)

The head chip includes a nozzle plate including a nozzle array with a plurality of nozzle holes, an actuator plate including a plurality of channels filled with the ink and communicating with the nozzle holes, and a cover plate joined to a surface of the actuator plate, and including a common ink chamber communicating with the channels.

Further, to protect the nozzle plate, there is a liquid jet head that includes a nozzle guard formed to cover the nozzle plate. The nozzle guard is formed such that a press process is applied to a thin plate such as stainless steel. A slit (opening portion) that exposes the nozzle array is formed in a portion of the nozzle guard, the portion corresponding to the nozzle array.

Here, in initial filling of the ink to the head chip or discharging the ink from the head chip, the ink may scatter around and adhere to the nozzle plate and the nozzle guard. Therefore, water-repellent film treatment is applied to the nozzle plate and the nozzle guard to suppress adhesion of the ink.

When applying the water-repellent film treatment to the nozzle guard, a water-repellent film may be separated due to a machining mark in the nozzle guard or residual stress at the time of forming the nozzle guard. Therefore, the water-repellent film treatment is applied after the nozzle guard is formed.

### SUMMARY

However, when applying the water-repellent film treatment after forming the nozzle guard, the water-repellent film treatment is separately applied to every component. Further, it is necessary to mask every joint portion between the nozzle guard and another component so that the water-repellent film is not formed on unintended portions. Therefore, there is a problem of an increase in manufacturing cost.

Further, when applying the water-repellent film treatment after forming the nozzle guard, distortion is caused near a portion to which a bending process or a drawing process of the nozzle guard is applied, and the film thickness of the water-repellent film in the portion where the distortion is caused becomes easily uneven. Therefore, there is a problem of a decrease in water-repellent performance of the nozzle guard.

Therefore, the present invention has been made in view of the foregoing, and provides a liquid jet head, a liquid jet recording device, and a method of manufacturing a liquid jet head that can suppress manufacturing cost and prevent a decrease in water-repellent performance due to unevenness of a film thickness of a water-repellent film.

To solve the problems, a liquid jet head according to the present invention includes: a nozzle plate including a nozzle array with a plurality of nozzle holes; an actuator plate including a plurality of channels to be filled with liquid and communicating with the nozzle holes; and a nozzle guard provided so as to cover the nozzle plate for protecting the nozzle plate, wherein the nozzle guard includes a frame body formed to surround a periphery of the nozzle plate, and a cover body which blocks an opening portion of the frame body, and in which a slit that exposes the nozzle array is formed, the frame body and the cover body are configured separately from each other, and the frame body and the cover body respectively include joint portions to be joined to each other.

With such a configuration, it becomes unnecessary to apply a press process to the cover body to which water-repellent film treatment is applied. Therefore, for example, the water-repellent film treatment can be collectively applied to a plurality of the cover bodies before the plurality of cover bodies is detached from a base material plate. Therefore, the manufacturing cost can be suppressed

Further, it is not necessary to apply the press process to the cover body, and the water-repellent film treatment can be applied to only a flat plane. Therefore, the film thickness of the formed water-repellent film can be made uniform. Therefore, the water-repellent performance of the nozzle guard can be improved.

In the liquid jet head according, at least one of the frame body and the cover body includes a plane direction positioning portion for positioning in a plane direction of the cover body with respect to the frame body.

With such a configuration, positioning of the slit formed in the cover body, and the nozzle holes and the nozzle array formed in the nozzle plate can be easily performed.

In the liquid jet head, the frame body and the cover body are formed into a rectangular shape, and the plane direction positioning portions are respectively provided to a pair of facing side surfaces of the frame body and the cover body.

With such a configuration, in a facing direction of the pair of side surfaces where the plane direction positioning portion is provided, positioning of the cover body with respect to the frame body can be accurately performed.

In the liquid jet head, the plane direction positioning portions are respectively provided to both side surfaces of the frame body and the cover body in a longitudinal direction.

Here, the slit formed in the cover body has little room in a short direction while formed with some room in the longitudinal direction, with respect to the nozzle holes and the nozzle array. This is because the letters and images to the recording medium can be made highly dense when an interval between the nozzle arrays is made as narrow as possible in a case where a plurality of the actuator plates is arranged side by side.

Therefore, by respectively providing the plane direction positioning portions to both side surfaces in the longitudinal direction of the frame body and the cover body, positioning in the short direction of the cover body with respect to the frame body can be accurately performed. As a result, when the plurality of actuator plates is arranged side by side, the interval between the nozzle arrays can be made as narrow as possible. Therefore, the quality of the liquid jet head can be improved.

In the liquid jet head, at least one of the frame body and the cover body includes a thickness direction positioning portion for positioning in a thickness direction of the cover body with respect to the frame body.

Here, it is desirable to bring the cover body and the nozzle plate into close contact with each other. If there is a gap between the cover body and the nozzle plate, the liquid (ink) discharged through the nozzle hole is impeded by the cover body, and the quality of the letters and images recorded on the recording medium may be degraded.

Therefore, by providing the thickness direction positioning portion to at least one of the frame body and the cover body, positioning in the thickness direction of the cover body with respect to the frame body can be accurately performed. As a result, the cover body and the nozzle plate can be accurately brought into close contact with each other, and a decrease in the quality in the letters and images recorded on the recording medium can be prevented.

In the liquid jet head, the thickness direction positioning portion is an outer flange portion provided in an outer peripheral portion of the cover body.

Further, the thickness direction positioning portion may be an inner flange portion provided in an inner peripheral portion of the opening portion of the frame body.

With such a configuration, positioning in the thickness direction of the cover body with respect to the frame body can be performed with the simple structure.

A liquid jet recording device according to the present invention includes: the above-described liquid jet head; a scanning unit configured to cause the liquid jet head to scan; a liquid accommodating body configured to accommodate the liquid; and a liquid supply pipe laid between the liquid jet head and the liquid accommodating body, and configured to circulate the liquid.

With such a configuration, a liquid jet recording device that can suppress manufacturing cost and prevent a decrease in water-repellent performance due to unevenness of a film thickness of a water-repellent film can be provided.

A method of manufacturing a liquid jet head according to the present invention includes a nozzle plate including a nozzle array with a plurality of nozzle holes, an actuator plate including a plurality of channels to be filled with ink and communicating with the nozzle holes, and a nozzle guard provided so as to cover the nozzle plate for protecting the nozzle plate, wherein the nozzle guard is formed by joining a frame body formed to surround a periphery of the nozzle plate, and a cover body configured separately from the frame body, and which blocks an opening portion of the frame body and in which a slot that exposes the nozzle array is formed, and water-repellent film treatment is applied to a surface of the cover body at an opposite side to a joint surface to the frame body before the cover body is joined to the frame body.

With such a method, the water-repellent film treatment that makes the film thickness uniform can be easily and accurately applied to the cover body. Further, for example, the water-repellent film treatment can be collectively applied to a plurality of the cover bodies before the plurality of cover bodies is detached from the base material plate. Therefore, the manufacturing cost can be suppressed.

In the method of manufacturing a liquid jet head, after the water-repellent film treatment is applied to the cover body, etching treatment is applied to a portion corresponding to the joint surface of the cover body, and an outer flange to be joined to the frame body is formed.

With such a method, for example, the outer flanges for joint can be collectively formed in the plurality of cover bodies before the plurality of cover bodies is detached from the base material plate. Therefore, the manufacturing cost can be suppressed.

In the method of manufacturing a liquid jet head, a plurality of the cover bodies is formed by being detached from one base material plate, and the cover bodies are detached from the base material plate after the water-repellent film treatment and the etching treatment are applied to the base material plate in advance.

With such a method, the water-repellent film and the etching treatment can be collectively and easily applied to the plurality of cover bodies. Therefore, the manufacturing cost can be suppressed.

According to the present invention, it becomes unnecessary to apply the press process to the cover body to which the water-repellent film treatment is applied. Therefore, for example, the water-repellent film treatment can be collectively applied to the plurality of cover bodies before the plurality of cover bodies is detached from the base material plate. Accordingly, the manufacturing cost can be suppressed.

Further, it is not necessary to apply the press process to the cover body, and the water-repellent film treatment can be applied to only a flat plane, and thus the film thickness of the water-repellent film to be formed can be made uniform. Therefore, the water-repellent performance of the nozzle guard can be improved.

### BRIEF DESCRIPTION OF DRAWINGS

FIG. 1 is a perspective view of a liquid jet recording device in an embodiment of the present invention;

FIG. 2 is a perspective view of a liquid jet head in an embodiment of the present invention;

FIG. 3 is a perspective view of a discharge unit in the first embodiment of the present invention;

FIG. 4 is an exploded perspective view of the discharge unit in the first embodiment of the present invention;

FIG. 5 is an exploded perspective view of a nozzle guard in the first embodiment of the present invention;

FIG. 6 is a sectional view along the A-A line of FIG. 4;

FIG. 7 is a plan view of a cover body in the first embodiment of the present invention as viewed from a frame body side;

FIGS. 8A and 8B are explanatory diagrams illustrating a step of manufacturing the cover body in the first embodiment of the present invention;

FIG. 9 is an explanatory diagram illustrating a step of manufacturing the cover body in the first embodiment of the present invention;

FIG. 10 is an explanatory diagram illustrating a step of manufacturing the cover body in the first embodiment of the present invention;

FIG. 11 is an explanatory diagram illustrating a step of manufacturing the cover body in the first embodiment of the present invention;

FIG. 12 is a principal portion enlarged sectional view of a nozzle guard in a second embodiment of the present invention; and

FIG. 13 is a principal portion enlarged sectional view of a nozzle guard in a third embodiment of the present invention.

### DETAILED DESCRIPTION

Next, embodiments of the present invention will be described on the basis of the drawings.

### First Embodiment

### (Liquid Jet Recording Device)

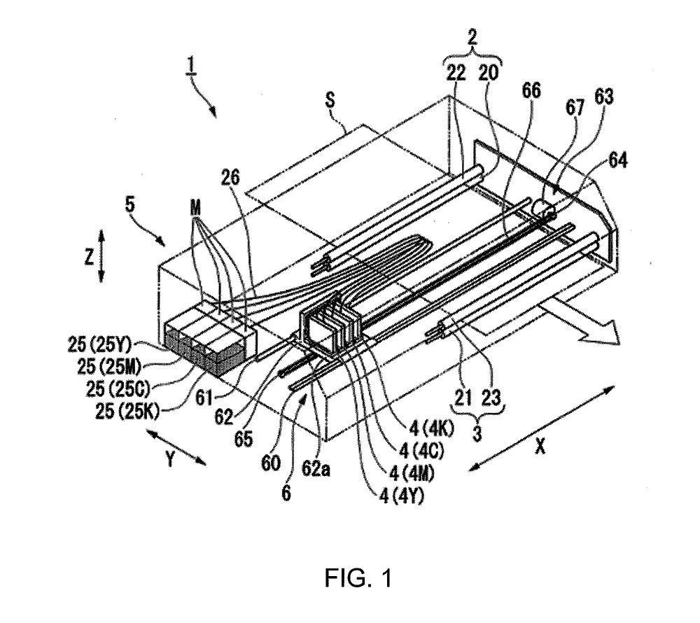

FIG. 1 is a perspective view of a liquid jet recording device 1.

The liquid jet recording device 1 is so-called an ink jet printer, and includes a pair of conveying mechanisms 2 and 3 that conveys a recording medium S such as paper, a liquid jet head 4 that injects ink drops on the recording medium S, a liquid supply unit 5 that supplies ink to the liquid jet head 4, and a scanning unit 6 that causes the liquid jet head 4 to scan in a direction (sub scanning direction) approximately perpendicular to a conveying direction (main scanning direction) of the recording medium S.

Note that, in the drawings used in description below, scales of members are appropriately changed to make the members have recognizable sizes.

Further, description below will be given, where the sub scanning direction is an X direction, the main scanning direction is a Y direction, and a direction perpendicular to the X direction and the Y direction is a Z direction. Here, the liquid jet recording device 1 is used by being placed such that the X direction and the Y direction become a horizontal direction, and the Z direction becomes an up and down direction of the gravity direction.

That is, in a state where the liquid jet recording device 1 is placed, the liquid jet head 4 scans the recording medium S along the horizontal direction (the X direction and the Y direction). Further, ink drops are injected downward from the liquid jet head 4 toward the gravity direction (downward in the Z direction), and the ink drops impact on the recording medium S.

The pair of conveying mechanisms 2 and 3 includes grid rollers 20 and 21 provided to extend in the X direction, pinch rollers 22 and 23 respectively extending in parallel to the grid rollers 20 and 21, and a drive mechanism such as a motor that rotates and operates the grid rollers 20 and 21 around an axis although details are not illustrated.

The liquid supply unit 5 includes a liquid accommodating body 25 in which the ink is accommodated, and a liquid supply pipe 26 that connects the liquid accommodating body 25 and the liquid jet head 4. A plurality of the liquid accommodating bodies 25 is provided, and for example, ink tanks 25Y, 25M, 25C, and 25K in which four types of inks including yellow, magenta, cyan, and black are accommodated are provided side by side. Pump motors M are respectively provided to the ink tanks 25Y, 25M, 25C, and 25K, and can press and move the inks to the liquid jet head 4 through the liquid supply pipe 26. The liquid supply pipe 26 is a flexible hose having flexibility, which can correspond to an operation of a carriage unit 62 that supports the liquid jet head 4.

Note that the liquid accommodating body 25 is not limited to the ink tanks 25Y, 25M, 25C, and 25K in which the four types of inks including yellow, magenta, cyan, and black are accommodated, and may include ink tanks in which a larger number of colors of inks is accommodated.

The scanning unit 6 includes a pair of guide rails 60 and 61 provided to extend in the X direction, the carriage unit 62 slidable along the pair of guide rails 60 and 61, and a drive mechanism 63 that moves the carriage unit 62 in the X direction. The drive mechanism 63 includes a pair of pulleys 64 and 65 arranged between the pair of guide rails 60 and 61, an endless belt 66 wound around the pair of pulleys 64 and 65, and a drive motor 67 that rotates and drives the one pulley 64.

The pair of pulleys 64 and 65 are arranged between both end portions of the pair of guide rails 60 and 61 with a space in the X direction. The endless belt 66 is arranged between the pair of guide rails 60 and 61, and the carriage unit 62 is connected to the endless belt 66. A plurality of liquid jet heads 4 is mounted on a base end portion 62a of the carriage unit 62. To be specific, liquid jet heads 4Y, 4M, 4C, and 4K individually corresponding to the four types of inks including yellow, magenta, cyan, and black are mounted side by side in the X direction.

### (Liquid Jet Head)

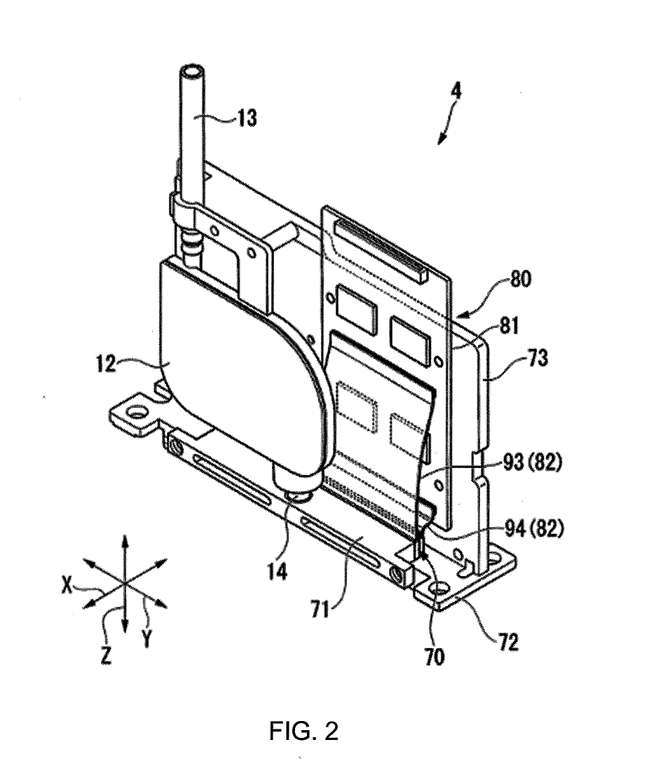

FIG. 2 is a perspective view of the liquid jet head 4Y, 4M, 4C, or 4K. Note that the liquid jet heads 4Y, 4M, 4C, and 4K are configured from the same configuration except the colors of the inks to be supplied. Therefore, in the description below, the liquid jet heads 4Y, 4M, 4C, and 4K are collectively described as the liquid jet head 4.

As illustrated in FIG. 2, the liquid jet head 4 includes a discharge unit 70 fixed on a lower base 72, and which injects ink drops to the recording medium S (see FIG. 1), a drive control unit 80 electrically connected to the discharge unit 70, and which controls driving of the discharge unit 70, a vertical base 73 that fixes the drive control unit 80, a liquid circulating portion 12 connected to the liquid supply pipe 26 through a connecting portion 13, and a flow channel member 71 connected to the liquid circulating portion 12 through a connecting portion 14.

The drive control unit 80 includes a circuit board 81, and a connecting board 82 for electrically connecting the circuit board 81 and the discharge unit 70.

The circuit board 81 is so-called a glass epoxy substrate, and is formed in an approximately rectangular shape long in the Z direction as viewed from the X direction. A control circuit (drive circuit) such as an integrated circuit for driving the discharge unit 70 is mounted on the circuit board 81.

The flow channel member 71 is connected to the discharge unit 70. Then, the ink flowing through the liquid supply pipe 26 is supplied to the discharge unit 70 through the liquid circulating portion 12 and the flow channel member 71. The liquid circulating portion 12 functions as a pressure damper. When the ink is supplied through the liquid supply pipe 26, the liquid circulating portion 12 stores the ink in a storage chamber therein, and then supplies a predetermined amount of the ink to the discharge unit 70. Note that the lower base 72 and the vertical base 73 may be integrally molded.

### (Discharge Unit)

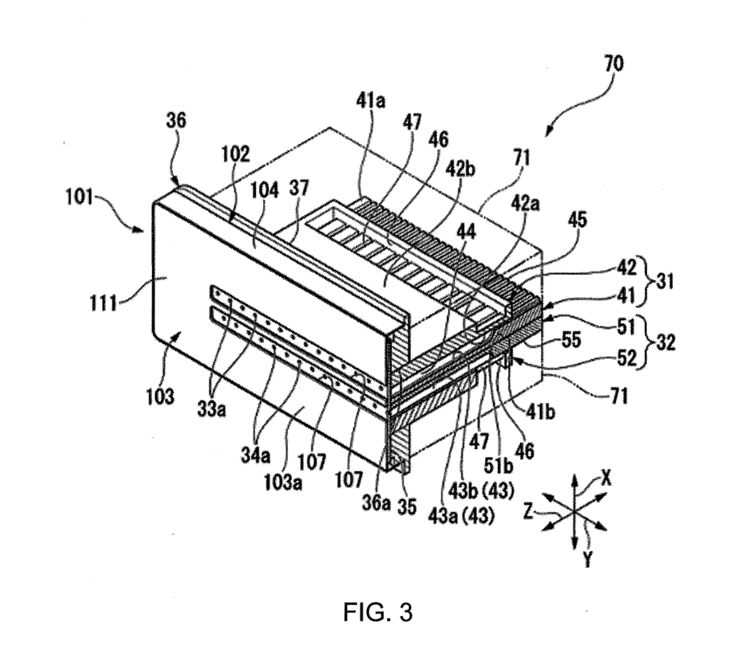

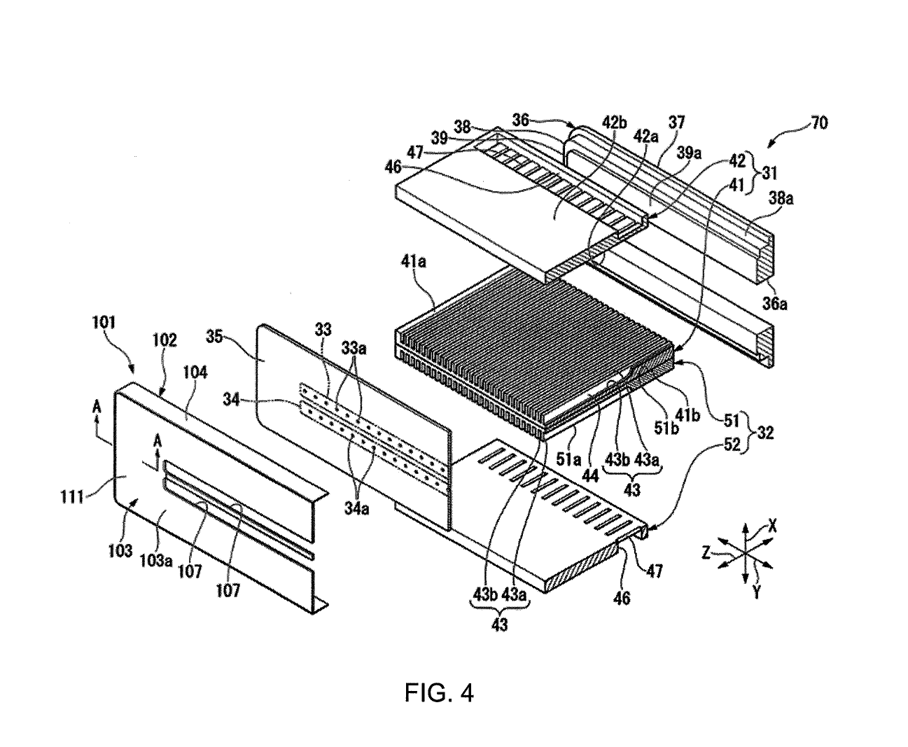

FIG. 3 is a perspective view of the discharge unit 70, and FIG. 4 is an exploded perspective view of the discharge unit 70.

As illustrated in FIGS. 3 and 4, the discharge unit 70 includes a first head chip 31 and a second head chip 32 that inject the ink to the recording medium S as droplets by being applied a voltage, a nozzle plate 35 provided on lower end surfaces (lowermost surfaces) of the first head chip 31 and the second head chip 32 in the Z direction, a nozzle guard 101 that protects the nozzle plate 35, and a nozzle cap 36 that supports the head chips 31 and 32, the nozzle plate 35, and the nozzle guard 101.

The first head chip 31 is so-called an edge shoot type head chip that discharges the ink through a first nozzle hole 33a communicating with an end portion of a discharge channel 43a described below in a longitudinal direction (Z direction). Then, a first actuator plate 41 and a first cover plate 42 are laminated in the X direction.

The first actuator plate 41 is a plate formed of piezoelectric material such as lead zirconate titanate (PZT), and a polarizing direction thereof is set along a thickness direction (X direction). A plurality of channels 43 is arranged side by side with a space in the Y direction on one principal plane 41a (a plane positioned on the first cover plate 42 side) of the first actuator plate 41 in the X direction.

The plurality of channels 43 is groove portions linearly extending along the Z direction in a state of opening to the one principal plane 41a side, and an end portion in the Z direction opens at a lower end surface of the first actuator plate 41. Drive walls 44 having a square shape in cross section and extending in the Z direction are formed between each two of the plurality of channels 43, and the channels 43 are divided by the drive walls 44.

Further, the plurality of channels 43 is roughly classified into discharge channels 43a to be filled with the ink and dummy channels 43b not filled with the ink. Then, these discharge channels 43a and the dummy channels 43b are alternately arranged side by side in the Y direction.

A drive electrode (not illustrated) is formed on an entire inner surface of the discharge channel 43a in the Z direction of the channel 43 by deposition or the like. Meanwhile, a dummy electrode (not illustrated) is formed on an entire inner surface of the dummy channel 43b in the Z direction of the channel 43.

Further, an upper portion in the Z direction of the one principal plane 41a of the first actuator plate 41 in the X direction is a first electrode pull-out portion 45. The first flexible board 93 (see FIG. 2) that configures the connecting board 82 is connected to the first electrode pull-out portion 45.

Then, the drive electrode and the dummy electrode (both are not illustrated) deform the drive wall 44 by piezoelectric sliding effect by being applied a voltage through the first flexible board 93, and changes the volume of the discharge channel 43a.

One principal plane 42a of the first cover plate 42 is joined to a position avoiding the first electrode pull-out portion 45, on the one principal plane 41a of the first actuator plate 41. The first cover plate 42 includes a recess common ink chamber 46 formed in the other principal plane 42b (a plane positioned at an opposite side to the first actuator plate 41) and a plurality of slits 47 causing the common ink chamber 46 and the discharge channels 43a to communicate with each other.

The common ink chamber 46 is a rectangular opening long along the Y direction and formed in a portion positioned in the other end portions of the channels 43 in the Z direction, of the first cover plate 42. The common ink chamber 46 communicates with the flow channel member 71, and the ink in the flow channel member 71 circulates in the common ink chamber 46.

The slits 47 are formed in positions of the common ink chamber 46, the positions corresponding to the discharge channels 43a, and allow the common ink chamber 46 and the discharge channels 43a to communicate with each other. The ink stored in the common ink chamber 46 circulates into the discharge channels 43a.

Meanwhile, the second head chip 32 is configured such that a second actuator plate 51 and a second cover plate 52 are laminated in the X direction. Note that a configuration of the second head chip 32 similar to that of the first head chip 31, of configurations of the second head chip 32, is denoted with the same reference sign, and description is omitted.

A plurality of channels 43 is arranged with a space in the Y direction on one principal plane 51a of the second actuator plate 51 at the same pitch as the channels 43 of the first actuator plate 41. Discharge channels 43a and dummy channels 43b of the second actuator plate 51 are alternately arranged with respect to the discharge channels 43a and the dummy channels 43b of the first actuator plate 41.

Therefore, in the discharge unit 70 of the present embodiment, the discharge channels 43a of the first actuator plate 41 and the discharge channels 43a of the second actuator plate 51 are arranged in a zigzag manner.

Further, the other principal planes 41b and 51b of the first actuator plate 41 and the second actuator plate 51 are joined to each other. Further, a position of the one principal plane 51a of the second actuator plate 51, the position facing the first electrode pull-out portion 45 of the first actuator plate 41, is a second electrode pull-out portion 55. The second flexible board 94 (see FIG. 2) that configures the connecting board 82 is connected to the second electrode pull-out portion 55.

Then, a drive electrode and a dummy electrode (both are not illustrated) of the second actuator plate 51 deform a drive wall 44 by piezoelectric sliding effect by being applied a voltage through the second flexible board 94. Accordingly, the drive electrode and the dummy electrode change the volume of the discharge channel 43a.

An external form of the nozzle cap 36 in plan view as viewed from the Z direction is formed into a rectangular shape, and is fixed in a state where its top surface butts against a lower surface of the lower base 72 (see FIG. 2).

Further, a fitting hole 36a penetrating in the Z direction is formed in the nozzle cap 36, and the first head chip 31 and the second head chip 32 are collectively fit into the fitting hole 36a.

Further, the nozzle cap 36 is formed into a plate shape with steps such that its external shape becomes smaller with the steps toward a lower end in a thickness direction. That is, the nozzle cap 36 is formed such that a base portion 37 positioned at an upper end side in the thickness direction (Z direction), a first step portion 38 arranged in a lower end surface of the base portion 37, and formed have an external shape that becomes smaller than the base portion 37, and a second step portion 39 arranged in a lower end surface of the first step portion 38, and formed to have an external shape that becomes smaller than the first step portion 38 are integrally molded. Then, the nozzle cap 36 is assembled such that an end surface 39a of the second step portion 39 becomes flush with the lower end surfaces of the first head chip 31 and the second head chip 32.

The nozzle plate 35 is a sheet made of a film material such as polyimide with the thickness of about 50 μm, and is joined to the end surface 39a of the second step portion 39 of the nozzle cap 36 with an adhesive or by heat sealing. The external shape of the nozzle plate 35 is formed to have a size corresponding to the external shape of the second step portion 39. Note that a water-repellent film for preventing adhesion of the ink and the like is formed on a facing surface (lower end surface) facing the recording medium S, in the nozzle plate 35.

Further, two arrays of nozzle arrays (a first nozzle array 33 and a second nozzle array 34) with plurality of nozzle holes (first nozzle holes 33a and second nozzle holes 34a) are arranged side by side with a space in the Y direction in the nozzle plate 35.

The first nozzle array 33 includes a plurality of the first nozzle holes 33a penetrating the nozzle plate 35 in the Z direction, and these first nozzle holes 33a are arranged in one straight line with a space in the Y direction. The first nozzle hole 33a is formed into a truncated cone shape to be gradually tapered toward a lower-side surface in the nozzle plate 35 in the Z direction. Further, the first nozzle holes 33a are formed in positions corresponding to the discharge channels 43a of the first actuator plate 41.

Meanwhile, the second nozzle array 34 includes a plurality of the second nozzle holes 34a penetrating the nozzle plate 35 in the Z direction, and is arranged in parallel to the first nozzle array 33. Further, the second nozzle hole 34a is also formed into a truncated cone to be gradually tapered toward a lower-side surface in the nozzle plate 35 in the Z direction. Further, the second nozzle holes 34a are formed in positions corresponding to the discharge channels 43a of the second actuator plate 51.

### (Nozzle Guard)

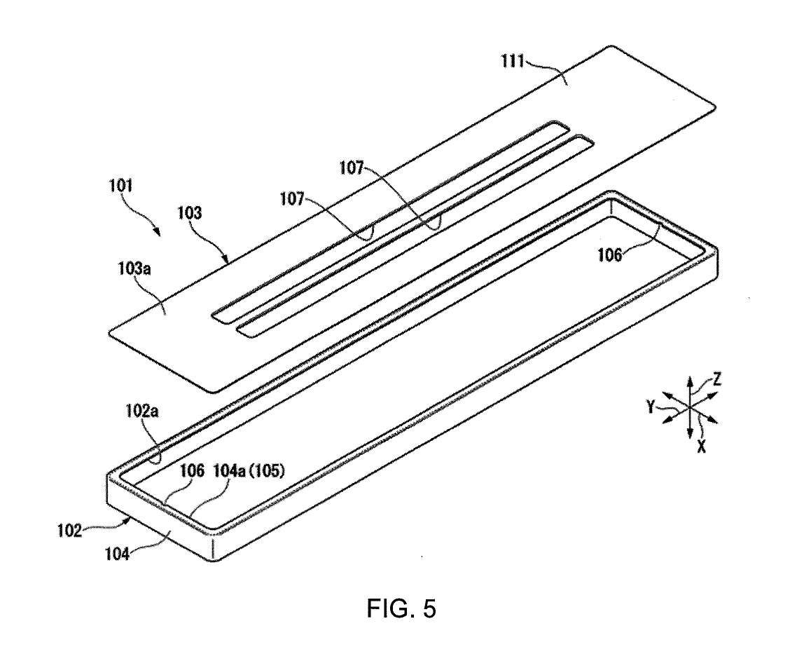

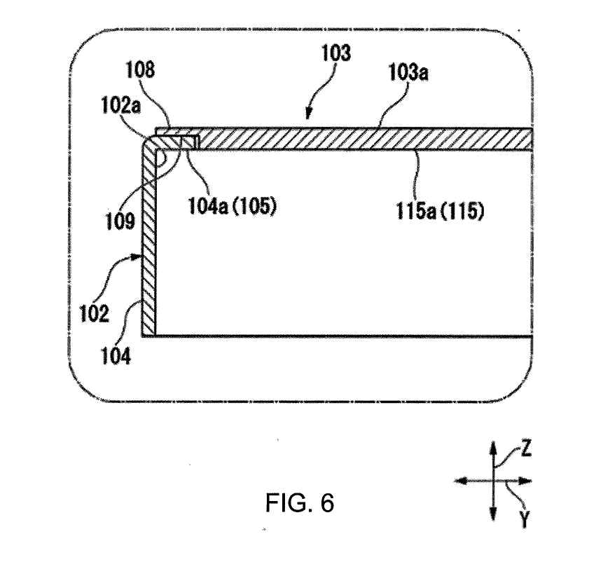

FIG. 5 is an exploded perspective view of the nozzle guard 101, and FIG. 6 is a sectional view along the A-A line of FIG. 4.

As illustrated in FIGS. 3 to 6, the nozzle guard 101 is formed of a stainless plate with the thickness of about 0.3 mm, for example. The nozzle guard 101 is integration of a frame body 102 formed into a frame shape, and a cover body 103 formed separately from the frame body 102 and which blocks an opening portion (hereinafter, referred to as lower opening portion) 102a at a lower side of the frame body 102 in the Z direction.

The frame body 102 is formed such that a press process is applied to a metal plate (for example, a stainless plate). A peripheral wall 104 of the frame body 102 is formed into a rectangular shape long in the Y direction so as to be fit into an outer peripheral surface 38a of the first step portion 38 that configures the nozzle cap 36. An inner flange portion 104a is formed in an inner peripheral edge of the peripheral wall 104 on the lower opening portion 102a side so as not to overlap with the nozzle arrays 33 and 34 of the nozzle plate 35 in the Z direction. In other words, the inner flange portion 104a is formed to extend not to block the nozzle arrays 33 and 34 with the inner flange portion 104a.

The inner flange portion 104a has a role as a joint surface 105 on which the cover body 103 is placed, and which joins the cover body 103 and the frame body 102. Further, positioning recess portions 106 are respectively formed in the inner flange portion 104a in approximately centers in the short direction (X direction), and in both sides in the longitudinal direction (Y direction). The positioning recess portions 106 have a role to determine relative positions of the frame body 102 and the cover body 103 (details will be described below).

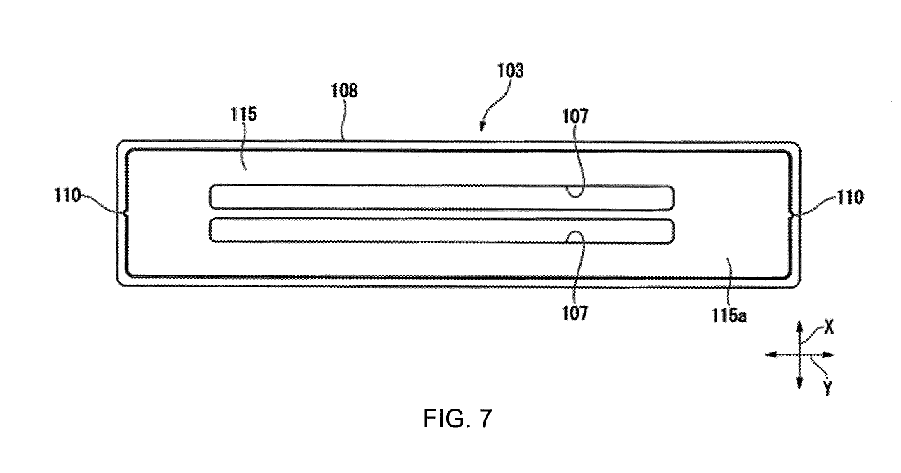

FIG. 7 is a plan view of the cover body 103 as viewed from the frame body 102 side.

As illustrated in FIGS. 5 to 7, the cover body 103 is a rectangular plate member long in the Y direction, and includes a cover main body 115 formed to be slightly smaller than the shape of an inner peripheral edge of the inner flange portion 104a. The cover main body 115 faces the nozzle plate 35 in the Z direction in a state where the nozzle guard 101 is attached to the nozzle cap 36. Two slits 107 that exposes the nozzle arrays 33 and 34 are formed in positions corresponding to the nozzle arrays 33 and 34 of the nozzle plate 35 in the cover main body 115. Therefore, the length of the two slits 107 in the Y direction is set to be longer than the space between the outermost-side nozzle holes 33a and 34a that configure the nozzle arrays 33 and 34.

Further, an outer flange portion 108 coming in contact with the inner flange portion 104a of the frame body 102 is integrally molded with an outer peripheral portion of the cover main body 115. The size of the outer peripheral shape of the outer flange portion 108 is formed to become nearly the same as the size of the shape of the outer peripheral surface side in the peripheral wall 104 of the frame body 102. Further, the outer flange portion 108 is formed to be thinner than the cover main body 115. Therefore, a surface of the outer flange portion 108 on the frame body 102 side has a shape extending through a step between the outer flange portion 108 and the cover main body 115. The surface of the outer flange portion 108 on the frame body 102 side is configured as a joint surface 109 for joining the frame body 102 and the cover body 103.

Under such a configuration, the surface of the outer flange portion 108, where the step is formed (the surface of the cover main body 115 on a back surface 115a side) is superimposed on the inner flange portion 104a (joint surface 105) of the frame body 102 from below in the Z direction (from above in FIGS. 5 and 6). Then, these inner flange portion 104a and outer flange portion 108 are fixed with an adhesive or the like, so that the nozzle guard 101 is formed.

Here, when the inner flange portion 104a of the frame body 102 and the outer flange portion 108 of the cover body 103 are superimposed, positioning in the thickness direction of the cover body 103 with respect to the frame body 102 is performed. That is, the inner flange portion 104a and the outer flange portion 108 has not only a role as the joint surfaces 105 and 109 that fix each other, but also a role as a thickness direction positioning portion for positioning in the thickness direction of the cover body 103 with respect to the frame body 102.

Further, in the state where the inner flange portion 104a of the frame body 102 and the outer flange portion 108 of the cover body 103 are superimposed, the outer peripheral portion of the cover main body 115 is fit into the inner peripheral portion side of the inner flange portion 104a. Then, the back surface 115a of the cover main body 115 on the frame body 102 side comes to a position flush with the inner flange portion 104a of the frame body 102, or a position slightly protruding from the inner flange portion 104a. Therefore, in a state where the nozzle guard 101 is attached to the nozzle cap 36, the back surface 115a of the cover main body 115 comes in close contact with the nozzle plate 35.

Further, since the cover main body 115 is formed to become slightly smaller than the shape of the inner peripheral edge of the inner flange portion 104a, backlash is caused between the cover main body 115 and the inner flange portion 104a in a state where the cover body 103 is attached to the frame body 102. With the backlash, a manufacturing error between the frame body 102 and the cover body 103 can be absorbed.

Here, a positioning projection portion 110 insertable into the positioning recess portion 106 is integrally molded with the joint surface 109 of the cover body 103 in a position corresponding to the positioning recess portion 106 formed in the inner flange portion 104a of the frame body 102. The positioning projection portion 110 is formed to be inserted into the positioning recess portion 106 with some backlash in the Y direction without the backlash in the X direction.

When the positioning projection portion 110 is inserted into the positioning recess portion 106, the positioning in a plane direction of the cover body 103 with respect to the frame body 102 is performed. Especially, the positioning recess portions 106 and the positioning projection portions 110 are respectively provided to both sides of the frame body 102 and the cover body 103 in the longitudinal direction (Y direction). Therefore, the positioning in the short direction (X direction) of the cover body 103 with respect to the frame body 102 is accurately performed.

Further, the surface (a plane on the ink discharge side) 103a of the cover body 103 at an opposite side to the joint surface 109 is formed flat. A water-repellent film 111 for preventing adhesion of the ink and the like is formed on this surface 103a.

### (Operation of Liquid Jet Recording Device)

Next, an operation when information is recorded on the recording medium S by the liquid jet recording device 1 configured as described above will be described.

In this case, as illustrated in FIG. 1, for example, the liquid jet heads 4 are reciprocated in a scanning direction X by the scanning unit 6 through the carriage unit 62 while the recording medium S is conveyed in a conveying direction Y by the pair of conveying mechanisms 2 and 3. During the movement, the drive control unit 80 applies the voltage to the drive electrodes and the dummy electrodes (both are not illustrated) through the flexible boards 93 and 94 in the liquid jet heads 4. Accordingly, the piezoelectric sliding effect is caused in the drive walls 44, and pressure waves are caused in the inks filled in the discharge channels 43a of the liquid jet heads 4.

With the pressure waves, inner voltages of the discharge channels 43a are increased. Therefore, the inks can be discharged through the nozzle holes 33a and 34a of the nozzle plate 35. At this time, the inks are discharged as ink drops when passing through nozzle holes 33a and 34a of the nozzle plate 35 and the slits 107 of the nozzle guard 101. As a result, various types of information such as letters and images are recorded on the recording medium S, using the four colors of inks.

### (Method of Manufacturing Cover Body of Nozzle Guard)

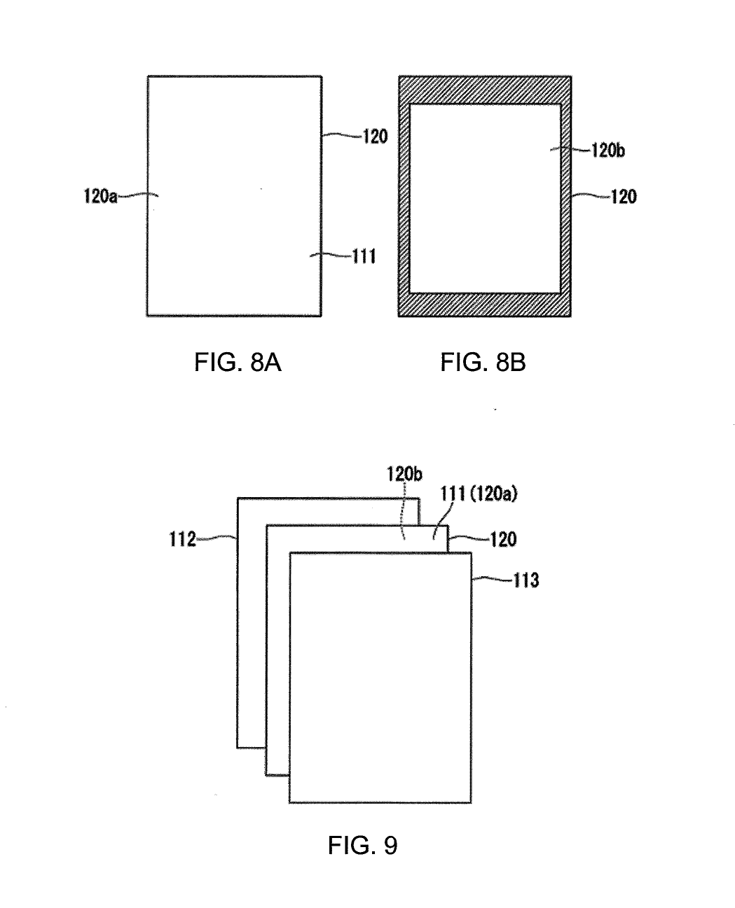

Next, a method of manufacturing the cover body 103 of the nozzle guard 101 will be described on the basis of the FIG. 8A to FIG. 11.

FIG. 8A to FIG. 11 are explanatory diagrams illustrating a process of manufacturing the cover body 103.

Here, a plurality of the cover bodies 103 is taken from a base material plate 120 made of a metal plate such as a stainless plate, for example.

First, as illustrated in FIG. 8A, the water-repellent film treatment is applied to a surface 120a of the base material plate 120, the surface 120a becoming the surface 103a of the cover body 103 subsequently, and the water-repellent film 111 is formed. At this time, as illustrated in FIG. 8B, the water-repellent film 111 may somewhat go around to an outer peripheral portion of the base material plate 120 on a back surface 120b side (in the shaded area illustrated in FIG. 8B). This is because, although details will be described below, the outer peripheral portion of the base material plate 120 becomes waste material. Therefore, a range of the outer peripheral portion of the back surface 120b to which the water-repellent film 111 may go around is defined according to a range of the back surface 120b that becomes the waste material subsequently.

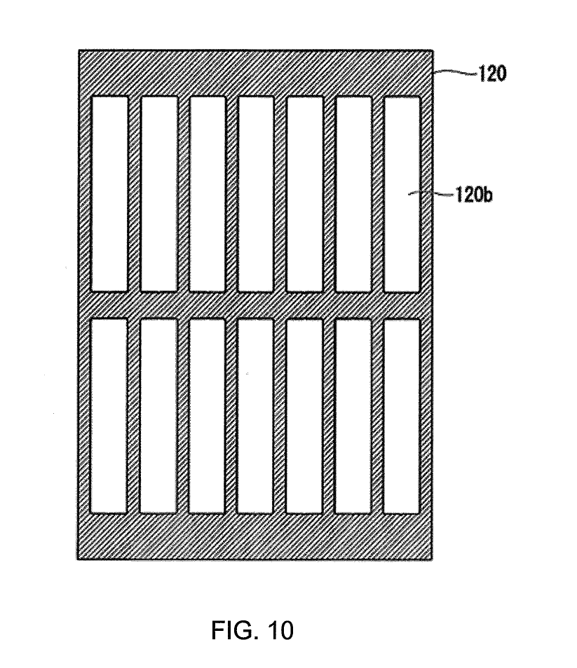

Next, as illustrated in FIG. 9, a protection film 113 is affixed to the plane (surface 120a) of the base material plate 120 on the side where the water-repellent film 111 is formed, and a resist 112 is affixed to the back surface 120b of the base material plate 120. The resist 112 is formed in a predetermined pattern. To be specific, the resist 112 is formed in a pattern in which a portion of the back surface 120b of the base material plate 120 except portions becoming the cover main body 115 and the positioning projection portion 110 subsequently is exposed (see FIG. 10).

Next, as illustrated in FIG. 10, the etching treatment is applied to the base material plate 120. A portion to which the etching treatment is applied (the portion to which no resist 112 is affixed (see the shaded area in FIG. 10)) becomes the outer flange portion 108 of the cover body 103 subsequently. Therefore, the etching treatment is performed until the thickness of the portion of the base material plate 120, to which the etching treatment is applied, becomes the same thickness as that of the outer flange portion 108. Then, at the point of time, the etching treatment is terminated.

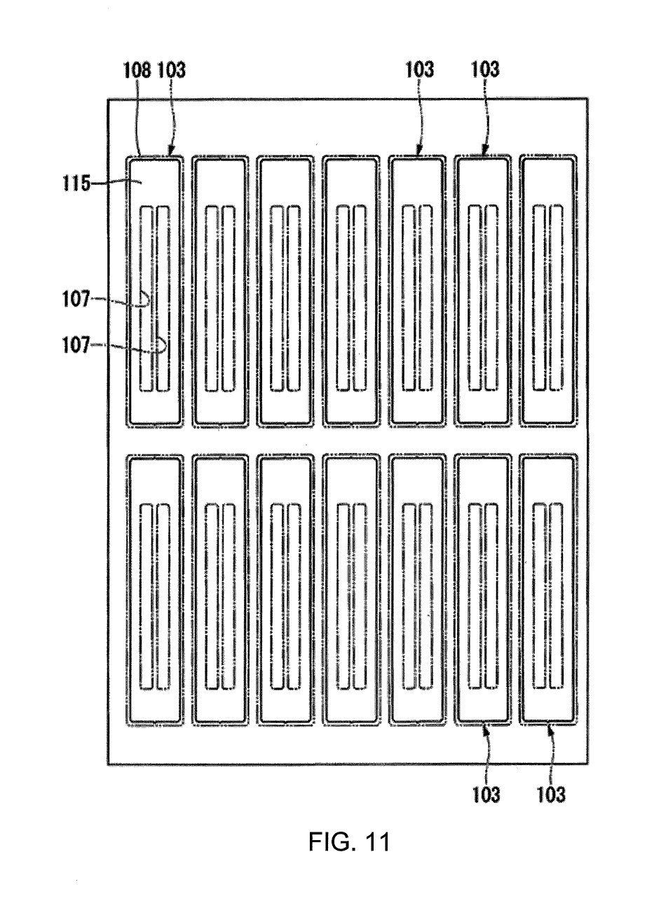

After the etching treatment is terminated, the protection film 113 and the resist 112 are peeled from the base material plate 120. Then, as illustrated in FIG. 11, a laser process is applied to the base material plate 120 along an outer peripheral shape (see the two-dot chain line in FIG. 11) of the cover body 103, and the plurality of cover bodies 103 is detached. At this time, the slits 107 are also formed at the same time by the laser process. Accordingly, manufacturing of the cover body 103 is completed.

Note that the base material plate 120 from which the cover bodies 103 are detached becomes waste material. Therefore, an outer peripheral portion of the waste material is the portion of the back surface 120b to which the water-repellent film 111 may go around in applying the water-repellent film treatment to the base material plate 120 (see the shaded area illustrated in FIG. 8B).

Then, the joint surface 109 of the cover body 103 manufactured as described above and the joint surface 105 of the frame body 102 manufactured by the press process in advance are fixed with an adhesive or the like, so that the nozzle guard 101 is completed (for example, see FIG. 4).

As described above, in the present first embodiment, the nozzle guard 101 is configured from the frame body 102 and the cover body 103 configured separately from the frame body 102. Then, the joint surface 105 is provided on the frame body 102, and the joint surface 109 is provided on the cover body 103, and these joint surfaces 105 and 109 are fixed with an adhesive or the like, so that the frame body 102 and the cover body 103 are integrated. Therefore, the water-repellent film treatment can be applied to only the portion of the nozzle guard 101 on which the water-repellent film 111 is formed, that is, only the cover body 103, in a separate process from the frame body 102. The cover body 103 does not require a bending process by the press process or the like, and thus the film thickness of the water-repellent film 111 can be made uniform. Therefore, water-repellent performance of the nozzle guard 101 can be improved.

Further, the water-repellent film treatment is applied to only the cover body 103. Therefore, the water-repellent film 111 can be collectively formed on the plurality of cover bodies 103 by applying the water-repellent film treatment before the cover bodies 103 are detached from the base material plate 120. Therefore, the manufacturing cost of the nozzle guard 101 can be suppressed, compared with a case in which the water-repellent film 111 is individually formed for each nozzle guard 101.

Further, the positioning recess portion 106 is formed in the inner flange portion 104a (joint surface 105) of the frame body 102, and the positioning projection portion 110 is formed on the outer flange portion 108 (joint surface 109) of the cover body 103. Therefore, positioning in the plan direction of the cover body 103 with respect to the frame body 102 can be performed only by inserting the positioning projection portion 110 into the positioning recess portion 106. Especially, the positioning recess portions 106 and the positioning projection portions 110 are respectively provided to both sides of the frame body 102 and the cover body 103 in the longitudinal direction (Y direction). Therefore, the positioning in the short direction (X direction) of the cover body 103 with respect to the frame body 102 can be highly accurately performed. As a result, the positioning of the slits 107 formed in the nozzle guard 101 (cover body 103) and the nozzle arrays 33 and 34 (nozzle holes 33a and 34a) formed in the nozzle plate 35 can be easily performed.

Here, the length of the slit 107 formed in the nozzle guard 101 in the Y direction is set to be longer than the space between the outermost-side nozzle holes 33a and 34a that configure the nozzle arrays 33 and 34. In contrast, the space between the nozzle arrays 33 and 34 is set to be as short as possible to increase the density (quality) of letters and images recorded on the recording medium S. Therefore, the width of the slit 107 in the short direction has little room with respect to the width of the nozzle arrays 33 and 34 (the diameters of the nozzle holes 33a and 34a).

Therefore, by highly accurately performing positioning in the short direction (X direction) of the cover body 103 with respect to the frame body 102 with the positioning recess portions 106 and the positioning projection portions 110, the ink drops discharged from the head chips 31 and 32 can be prevented from being impeded by the nozzle guard 101. As a result, the quality of the letters and images recorded on the recording medium S can be improved.

Further, in the nozzle guard 101, the inner flange portion 104a is provided to the frame body 102, and the outer flange portion 108 is provided to the cover body 103, and the inner flange portion 104a and the outer flange portion 108 are used to function as the thickness direction positioning portion that performs the positioning in the thickness direction of the cover body 103 with respect to the frame body 102. Therefore, when the cover body 103 is attached to the frame body 102, whether the back surface 115a of the cover main body 115 is flush with the inner flange portion 104a of the frame body 102, or is in the position slightly protruding from the inner flange portion 104a can be highly accurately determined with the simple structure. As a result, the back surface 115a of the cover main body 115 can be brought into close contact with the nozzle plate 35 in the state where the nozzle guard 101 is attached to the nozzle cap 36. With the close contact, the ink drops discharged through the nozzle holes 33a and 34a can be prevented from being impeded by the cover body 103. Therefore, discharge performance of the liquid jet head 4 can be improved.

Further, in manufacturing the cover body 103 of the nozzle guard 101, the etching treatment is applied before the cover bodies 103 are detached from the base material plate 120 after the water-repellent film treatment is applied to the surface 120a of the base material plate 120. Therefore, the etching treatment can be collectively applied to the plurality of cover bodies 103, and the outer flange portion 108 can be formed. Therefore, the manufacturing cost of the nozzle guard 101 can be further suppressed.

Note that, in the first embodiment, a case in which the protection film 113 and the resist 112 are peeled from the base material plate 120 after the etching treatment is terminated, and then the laser process is applied to the base material plate 120 and the plurality of cover bodies 103 is detached from the base material plate 120, in manufacturing the cover body 103, has been described. However, an embodiment is not limited thereto. For example, after the plurality of cover bodies 103 is detached from the base material plate 120, the protection film 113 and the resist 112 may be peeled.

Further, the plurality of cover bodies 103 may be detached from the base material plate 120 with a dicing blade or the like in place of the laser process.

Further, in the first embodiment, a case in which the positioning recess portions 106 are provided to both sides of the inner flange portion 104a of the frame body 102 in the longitudinal direction (Y direction), and the positioning projection portions 110 are provided to both sides of the outer flange portion 108 of the cover body 103 in the longitudinal direction (Y direction) has been described. However, an embodiment is not limited thereto. The positioning projection portions 110 may be provided to the frame body 102 side, and the positioning recess portions 106 may be provided to the cover body 103 side. Further, ones of the positioning recess portions 106 and the positioning projection portions 110 may be provided to both sides of the frame body 102 in the short direction, and the other ones may be provided to both sides of the cover body 103 in the short direction.

Further, a plane direction positioning portion that performs positioning in the plane direction of the other cover body 103 may be provided to only one of the frame body 102 and the cover body 103. For example, positioning in the plane direction of the cover body 103 with respect to the frame body 102 may be performed by providing a projection portion to one of the frame body 102 and the cover body 103, and bringing the projection portion to butt against the other frame body 102 or the other cover body 103.

Further, in the first embodiment, a case in which the inner flange portion 104a is provided in the frame body 102 and the inner flange portion 104a is used as the joint surface 105, and the outer flange portion 108 is provided in the cover body 103 and the outer flange portion 108 is used as the joint surface 109 has been described. Further, a case in which the surface of the outer flange portion 108, in which the step is formed (the surface of the cover main body 115 on the back surface 115a side), is superimposed on the inner flange portion 104a has been described.

However, a configuration to fix the frame body 102 and the cover body 103 is not limited to the above-described configuration. For example, configurations below are exemplified. Hereinafter, other embodiments of the nozzle guard 101 will be specifically described with reference to the drawings.

### Second Embodiment

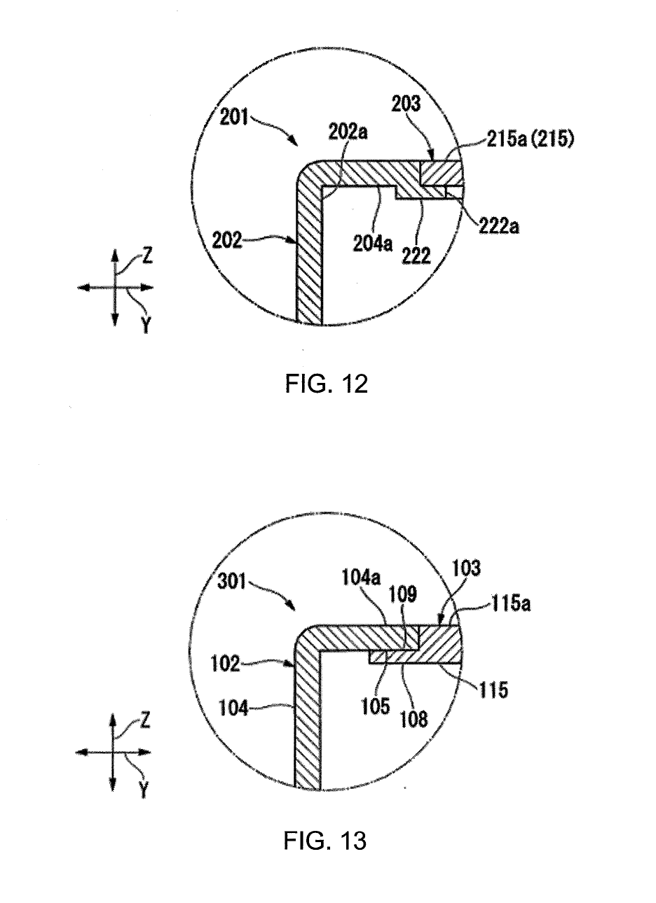

FIG. 12 is a principal portion enlarged sectional view of a nozzle guard 201 in a second embodiment, and corresponds to FIG. 6.

Note that the nozzle guard 201 is similar to the nozzle guard 101 of the first embodiment (the same applied to the following embodiment) in basic configurations including a point in which the nozzle guard 201 is formed of a stainless plate with the thickness of about 0.3 mm, and a point in which a frame body 202 formed into a frame shape, and a cover body 203 configured separately from the frame body 202 and which blocks a lower opening portion 202a are integrated.

Here, a frame-like joint flange portion 222 is integrally molded to protrude into an inner periphery side, with a surface (a top surface in a Z direction) on a periphery-side nozzle plate 35 (not illustrated in FIG. 12) side, of an inner flange portion 204a formed in the frame body 202 of the nozzle guard 201 in the second embodiment. The size of an opening portion 222a of the joint flange portion 222 is set to be slightly larger than an outer peripheral shape of the nozzle plate 35.

Meanwhile, a cover body 203 in the second embodiment is configured from only a cover main body 215, and does not include an outer flange portion 108 (see FIG. 6). The cover main body 215 is fit into an inner peripheral portion of the inner flange portion 204a of the frame body 202 in a state where the outer peripheral portion is placed on the joint flange portion 222. That is, the joint flange portion 222 and the outer peripheral portion of the cover main body 215 have a role as a joint surface that fixes the frame body 202 and the cover body 203.

Note that, in the cover main body 215 placed on the joint flange portion 222, a surface 215a at an opposite side to the nozzle plate 35 is flush with the inner flange portion 204a.

Under such a configuration, when the nozzle guard 201 is attached to a nozzle cap 36 (see FIGS. 3 and 4), the nozzle plate 35 faces the opening portion 222a of the joint flange portion 222, and the nozzle plate 35 and the cover body 203 (cover main body 215) are brought into close contact with each other.

Therefore, the second embodiment has similar effect to the first embodiment.

Note that, in the second embodiment, a case in which the surface 215a at the opposite side to the nozzle plate 35, of the cover main body 215 placed on the joint flange portion 222, is nearly flush with the inner flange portion 204a has been described. However, an embodiment is not limited thereto, and the cover main body 215 may slightly protrude downward in the Z direction from the inner flange portion 204a.

Here, a liquid jet recording device 1 may often include a wiper (not illustrated) that wipes the ink adhering to the nozzle plate 35 and the nozzle guard 201 (including the nozzle guard 101). By causing the wiper to perform a wiping operation, the inks adhering to the nozzle plate 35 and the nozzle guard 201 can be wiped. Therefore, when the cover main body 215 slightly protrudes downward in the Z direction from the inner flange portion 204a, the wiping work on the nozzle guard 201 (cover main body 215) with the wiper can be easily performed.

### Third Embodiment

FIG. 13 is a principal portion enlarged sectional view of a nozzle guard 301 in a third embodiment, and corresponds to FIG. 6. Note that, in the third embodiment, the same form as that of the first embodiment is denoted with the same reference sign, and description is omitted.

Here, in the third embodiment, a surface of an outer flange portion 108, where a step is formed (a surface of a cover main body 115 on a back surface 115a side), is superimposed on an inner flange portion 104a of a frame body 102 from above in a Z direction (from below in FIG. 13). This is a different point from the first embodiment. In this case, the back surface 115a of the cover main body 115 faces downward in the Z direction (upward in FIG. 13), unlike the first embodiment.

Even with such a configuration, a cover body 103 and a nozzle plate 35 (not illustrated in FIG. 13) can be brought into close contact with each other.

Note that the back surface 115a of the cover main body 115 may be configured to become flush with the inner flange portion 104a of the frame body 102, or may be configured to slightly protrude from the inner flange portion 104a. In a case where the cover main body 115 slightly protrudes from the inner flange portion 104a, wiping work on a nozzle guard 301 (cover main body 115) with a wiper can be easily performed.

The present invention is not limited to the above-described embodiments, and includes those obtained by adding various changes to the above-described embodiments without departing from the gist of the present invention. For example, the first to third embodiments may be appropriately combined.

Further, in the above-described embodiments, cases in which the nozzle guards 101, 201, and 301 are formed of stainless plate have been described. However, the nozzle guards 101, 201, and 301 are not limited thereto, and can be formed of various metal plates.

Further, in the above-described embodiments, a case of the discharge unit 70 has been described, in which the two head chips 31 and 32 (the first head chip 31 and the second head chip 32) are laminated to form the two arrays of the nozzle arrays (the first nozzle array 33 and the second nozzle array 34) with the plurality of nozzle holes (the first nozzle holes 33a and the second nozzle holes 34a) in the nozzle plate 35. However, the discharge unit is not limited thereto, and may be configured from one head chip without laminating the two head chips 31 and 32. Further, the discharge unit may be configured from two or more laminated head chips. In this case, a plurality of the discharge units 70, each of the discharge units 70 being made of the two laminated head chips 31 and 32, may be laminated

Further, in the above-described embodiments, so-called an ink jet printer has been exemplarily described as an example of the liquid jet recording device 1. However, the liquid jet recording device 1 may be a facsimile device or on-demand printing machine, or the like.

Further, in the above-described embodiments, the liquid jet recording device 1 for a plurality of colors, on which a plurality of the liquid jet heads 4 is mounted has been described. However, the liquid jet recording device 1 is not limited thereto, and the liquid jet head 4 may be for a single color, for example.

Further, in the above-described embodiments, the edge shoot-type head chips 31 and 32 have been exemplarily described. However, the head chips are not limited to the example, and so-called side shoot-type head chips that discharge inks through nozzle holes facing the center of channels 43 in a longitudinal direction may be employed.

What is claimed is:

1. A liquid jet head comprising:
a nozzle plate including a nozzle array with a plurality of nozzle holes;
an actuator plate including a plurality of channels to be filled with liquid and communicating with the nozzle holes; and
a nozzle guard provided so as to cover the nozzle plate for protecting the nozzle plate, wherein
the nozzle guard includes
a frame body formed to surround a periphery of the nozzle plate, and
a cover body which blocks an opening portion of the frame body, and in which a slit that exposes the nozzle array is formed,
the frame body and the cover body are configured separately from each other, and
the frame body and the cover body respectively include joint portions to be joined to each other.

2. The liquid jet head according to claim 1, wherein
at least one of the frame body and the cover body includes a plane direction positioning portion for positioning in a plane direction of the cover body with respect to the frame body.

3. The liquid jet head according to claim 2, wherein
the frame body and the cover body are formed into a rectangular shape, and
the plane direction positioning portions are respectively provided to a pair of facing side surfaces of the frame body and the cover body.

4. The liquid jet head according to claim 3, wherein
the plane direction positioning portions are respectively provided to both side surfaces of the frame body and the cover body in a longitudinal direction.

5. The liquid jet head according to claim 1, wherein
at least one of the frame body and the cover body includes a thickness direction positioning portion for positioning in a thickness direction of the cover body with respect to the frame body.

6. The liquid jet head according to claim 5, wherein
the thickness direction positioning portion is an outer flange portion provided in an outer peripheral portion of the cover body.

7. The liquid jet head according to claim 5, wherein
the thickness direction positioning portion is an inner flange portion provided in an inner peripheral portion of the opening portion of the frame body.

8. The liquid jet head according to claim 6, wherein
the thickness direction positioning portion is an inner flange portion provided in an inner peripheral portion of the opening portion of the frame body.

9. A liquid jet recording device comprising:
the liquid jet head according to claim 1;
a scanning unit configured to cause the liquid jet head to scan;
a liquid accommodating body configured to accommodate the liquid; and
a liquid supply pipe laid between the liquid jet head and the liquid accommodating body, and configured to circulate the liquid.
